(19) United States
(12) Patent Application Publication
(10) Pub. No.: US 2013/0103548 A1
(43) Pub. Date: Apr. 25, 2013

(54) SENDING AND RECEIVING DIGITAL GOODS THROUGH A SERVICE PROVIDER

(71) Applicant: Vijay Venugopal, Chennai (IN)

(72) Inventor: Vijay Venugopal, Chennai (IN)

(73) Assignee: eBay Inc., San Jose, CA (US)

(21) Appl. No.: 13/277,557

(22) Filed: Oct. 20, 2011

(51) Int. Cl. G06Q 30/06

(52) U.S. Cl. 705/26.44; 705/26.1

(57) ABSTRACT

A service facilitates purchases of digital goods in which the purchaser may receive the purchased goods or send them on to another person, e.g., as a gift or as a purchase made on another's behalf. The service may be needed in a situation where a buyer has made on online purchase of an item of digital goods but then finds that it is difficult to share or transfer the purchased goods due to copyright protection or digital rights management (DRM) protection. Using the service a purchaser may send digital goods after payment to the seller via the service in such a way that copyright protection and other digital goods rights are maintained. Embodiments include: communicating with a buyer and a seller as an intermediary; making payment via the intermediary for an item of digital goods; and making a delivery for the item via the intermediary for disposal by the buyer.

### BACKGROUND

1. Technical Field

Embodiments of the present invention generally relate to methods and systems for facilitating commerce and, more particularly, for facilitating buying and sending digital goods, via a service provider, from a user of the service provider to be received by another, who may also be a user of the service provider.

2. Related Art

In today's media market, it is not at all uncommon to sell and deliver digital content such as files, software, art, photographs, music, and movies through a number of electronic sources. This is usually referred to as digital e-commerce or digital download delivery. Digital goods is a general term that may be used in e-commerce to refer to any goods that are stored, delivered, or used electronically and may be used in a variety of industries, such as gaming, online content, and premium video. Examples of digital goods include e-books, music files, games, video, news articles, media content, software, digital images, website templates, manuals in electronic format, or any item which can be electronically stored in a file or multiple files. People also purchase digital goods in all sorts of online applications ranging from social networking apps (applications) and games to massively multiplayer online games. Some of the most popular items of these digital goods include virtual goods such as virtual money and virtual weapons. Free-to-play games, where one can start playing for free and then buy items in the game as one needs them, also account for a large amount of virtual goods transactions.

Digital goods may be delivered electronically to the consumer through e-mail, for example, or by download from the Internet. Usually when purchasing digital goods online, after the merchant has received payment the merchant may provide the digital goods item as an e-mail attachment or may provide the purchaser with a secure link where the purchaser can download the item.

### SUMMARY

According to one or more embodiments of the present invention, a user having an account with a financial service provider (FSP) may send digital goods purchased by the user to another user who may also have an account with the FSP or may be provided with an FSP account login identification for receiving the digital goods. For example, when a user buys digital goods (e.g., a song) using her FSP account, the user may be provided an option to save the digital goods to the user's FSP account in such a way that copyright protection and other digital goods rights are maintained. Sending and receiving digital goods within or between countries may be allowed in accordance with the rules (e.g., copyright or digital rights management) for each country. For example, once the digital goods are sent to another user the digital goods may be removed from the purchasing user's account by the FSP. In an alternative example, the digital goods could be downloaded to the user's account, and once downloaded locally the digital goods would not be allowed to be sent to others. In another alternative example, a pre-paid link may be provided to the recipient for downloading by the recipient directly from the digital goods seller. In another alternative example, a user buys digital goods using an FSP account and the user would like to send information about the digital goods (e.g., a merchant website link) to another user without paying for the digital goods. The service may provide the ability to send the link to any number of users so that any receiving user, if interested, can create an account with the FSP (if the receiving user did not already have one) and buy the digital goods directly from the merchant website.

In one or more embodiments, a system includes: a processor for communication over a network with a buyer and a seller, the processor executing a process that provides an intermediary between the buyer and the seller in which: a payment is made to the seller for an item of digital goods via the intermediary from the buyer; and a delivery is made from the seller for the item of digital goods via the intermediary for disposal by the buyer.

In another embodiment, a method includes: communicating via a computer network with a buyer and a seller so as to provide an intermediary between the buyer and the seller; making a payment, by a processor, via the intermediary from the buyer to the seller for an item of digital goods; and making a delivery from the seller for the item of digital goods via the intermediary for disposal by the buyer.

In a further embodiment, a computer program product comprises a computer readable medium having computer readable and executable code for instructing a processor to perform a method that includes: communicating via a computer network with a buyer and a seller so as to provide an intermediary between the buyer and the seller; making a payment via the intermediary from the buyer to the seller for an item of digital goods; and making a delivery from the seller for the item of digital goods via the intermediary for disposal by the buyer.

### BRIEF DESCRIPTION OF THE DRAWINGS

FIG. 1 is a system diagram illustrating a system for digital goods commerce in accordance with an embodiment of the present invention.

FIG. 2 is a process flow diagram illustrating one or more digital goods transactions in a system for digital goods commerce in accordance with an embodiment.

FIG. 3 is a flow chart illustrating a method for sending and receiving digital goods in a system for digital goods commerce in accordance with an embodiment.

### DETAILED DESCRIPTION

Embodiments of the present invention provide methods and systems for implementing a service that facilitates purchases of digital goods in which the purchaser has an option to receive the purchased goods for him or herself or to send the purchased goods on to another person, e.g., as a gift or as a purchase made on another's behalf. The need for such a service may arise in a situation where a purchaser has bought an item of digital goods—for example, using an online payment service such as provided by PayPal, Inc. of San Jose, Calif.—but then finds that it may be difficult to share or transfer the purchased goods due to copyright protection or digital rights management (DRM) protection of the digital goods. Using a digital goods sending and receiving service according to one embodiment a purchaser may send digital goods to another (or to him or herself)—after payment to the seller via the service provider—in such a way that copyright protection and other digital goods rights are maintained.

Embodiments of the digital goods sending and receiving service, as well as the online payment service, may be provided by a financial service provider (FSP)—such as PayPal, Inc. of San Jose, Calif.—in which a user of the service may have an account with the FSP (referred to as an “FSP account). In one or more embodiments, various mechanisms may be provided for sending digital goods including, for example, using the sender's FSP account and a sender's digital goods “locker” provided by the FSP, using a receiver's digital goods locker provided by the FSP, using email, or providing for the receiver to receive the digital goods directly from the seller.

Embodiments of the digital goods sending and receiving service may operate in accordance with various revenue models that may provide, for example, income or increased business volume to the service provider (e.g., the FSP). For example, a nominal fee may be charged for each transaction, or transactions may be provided free of charge with the incentive of opening a new FSP account for a new user.

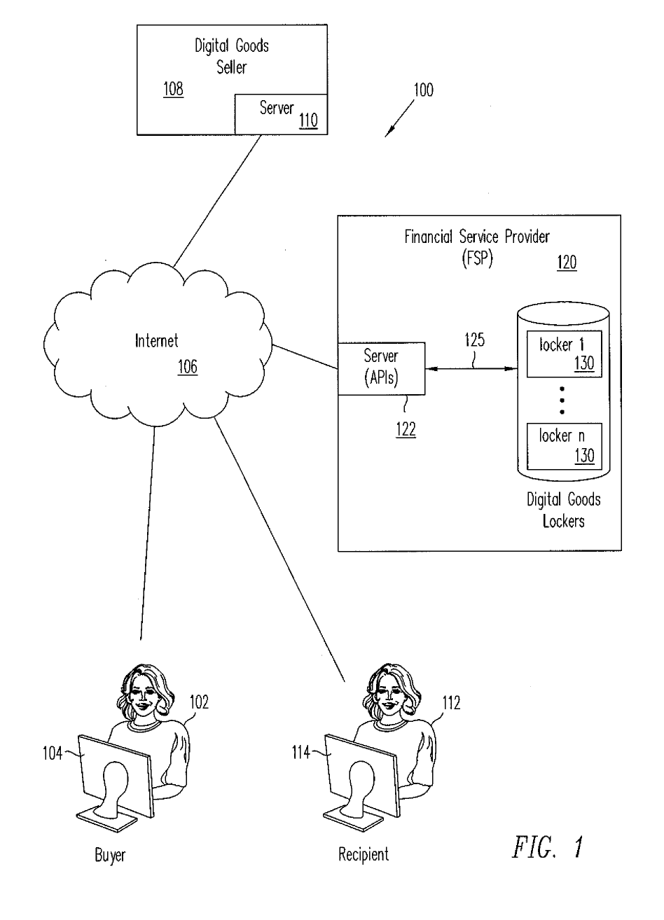

FIG. 1 illustrates a system 100 for digital goods commerce according to one embodiment. A buyer 102 (also referred to as a user of FSP services) may communicate via a device 104 (e.g., a computer, cell phone, pad, or other consumer electronic device) with FSP 120 via a network 106, such as the Internet. Buyer 102 may also communicate via network 106 with a seller 108. Seller 108 may sell digital goods through a website and may communicate with buyer 102, for example, by operating a server 110 (e.g., a computer processor) that presents a website for selling digital goods, the server 110 responding to client devices (e.g., device 104) by communicating over network 106. Seller 108 may also communicate (for example, using server 110) with FSP 120 through FSP server 122 over network 106. For example, seller 108 may communicate with FSP 120 in the course of various services offered by FSP 120 to seller 108, such as payment intermediary between customers (e.g., buyer 102) of seller 108 and seller 108. Similarly, a recipient 112 may communicate using an electronic device 114 over network 106 with any of buyer 102, seller 108, and FSP 120, each of which also may communicate with recipient 112 using network 106 via device 114. FSP server 122 may execute various application programming interfaces (APIs), as shown in FIG. 1, that may enable various different types of relationships between FSP 120 and the different parties shown in FIG. 1. For example, seller 108 may use an API that allows it to offer sale of goods in which customers are allowed to make payment through FSP 120, while buyer 102 may have an account with FSP 120, managed by a different API, that allows buyer 102 to use the FSP 120 for making payments to sellers that allow use of FSP 120 as a payment intermediary.

As shown in FIG. 1, FSP 120 may provide electronic data storage for digital goods in the form of digital goods lockers 130. There may be any number “n” of digital goods lockers as shown in FIG. 1. Ordinarily “n” may be quite large; for example, at least one locker may be provided for each user or account maintained by FSP 120. Digital goods lockers 130 may provide storage for digital goods products sold by digital goods merchants, such as seller 108, that is safe in that each seller 108 may be assured that copyright protections and other protections for the digital goods, such as digital rights management (DRM) protections, will not be compromised. For example, access to the lockers by sellers, buyers, and recipients may be strictly managed in a secure way by FSP 120 so that access 125 is provided to the digital goods lockers only through FSP 120 and not directly (e.g., no direct access for a buyer or recipient), as indicated by the representation of access 125 in FIG. 1. For example, when a user (e.g., buyer 102) buys digital goods (e.g., a song) using an FSP account, the user may be provided an option to save the digital goods to one of the digital goods lockers associated with the user's FSP account. Then, the digital goods may be sent to any FSP user using either an email or an FSP login identification (ID). In one alternative, the digital goods may be removed from the sender's locker and placed in the recipient's locker in the case that both sender and recipient have FSP accounts.

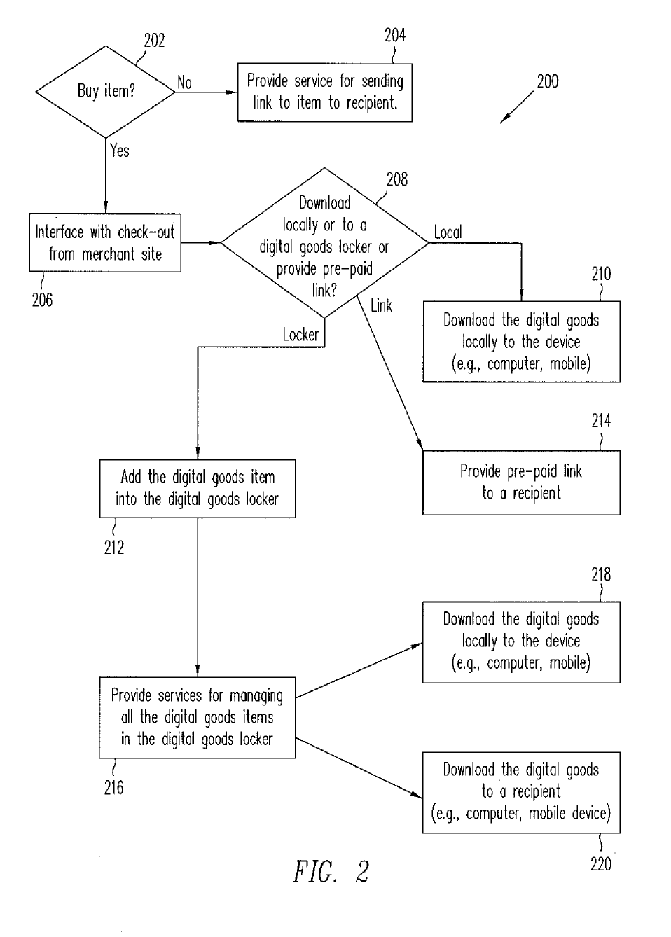

FIG. 2 illustrates a method 200, according to one embodiment, showing a process flow for one or more digital goods transactions involving sending and receiving digital goods in a system such as system 100 for digital goods commerce. At step 202, a user of services provided by FSP 120, such as buyer 102 who may have an FSP account with FSP 120, may be shopping online, for example, at a website of a digital goods merchant, such as seller 108. The user may decide whether or not to buy a particular item of digital goods, and if yes, method 200 may continue at step 206, and if no, method 200 may continue at step 204.

At step 204, FSP 120 may provide a service to the user (e.g., buyer 102) that allows the user to send an information link for the item to a recipient 112 without buying the item. For example, FSP 120 may provide a mouse click button that allows the user to easily email the information link to the recipient, who may then use the link to visit the merchant website directly, where the recipient may decide whether or not to buy the item from the merchant and whether or not to pay using the recipient's FSP account or establish an FSP account if the recipient does not already have an FSP account.

At step 206, if the user (e.g., buyer 102) decides to buy an item from the digital goods merchant website (e.g., seller 108), the FSP 120 may interface with the merchant website via server 122, network 106, and merchant server 110 to provide an interface with the checkout process at the merchant website so that the buyer 102 can use the FSP as an intermediary to pay for the item, which the buyer may decide to keep or to send on to another person (e.g., recipient 112). In the most general terms, the recipient 112 may also refer to the buyer 102 so that a buyer may actually send the item to him or herself for whatever reason. If the buyer 102 has an FSP account, the FSP interface with checkout from the merchant site may allow buyer 102 to pay for the item via the FSP as intermediary, or alternatively, the FSP interface with checkout from the merchant site may allow buyer 102 to establish an FSP account and then pay for the item via the FSP as intermediary using the newly established FSP account.

At step 208, while in the checkout process at the merchant website or while interfacing with the FSP as intermediary (or a combination of the two) the process flow of method 200 may branch in one or more of several directions depending on the buyer decision expressed at step 206. As shown in FIG. 2, method 200 may continue at step 210 if a local download of the digital goods item is appropriate; method 200 may continue at step 212 if download of the digital goods item to a digital goods locker is appropriate; and method 200 may continue at step 214 if the use of prepaid link to the item of digital goods is appropriate.

For example, if buyer 102 has decided to keep the item for herself, the buyer 102 may be allowed, at step 210, to download the digital goods locally to her device (e.g., device 104) from the website. The local download may be performed in the usual manner that the website (e.g., seller 108) makes delivery for an item (e.g., in this case a delivery for the item may include an actual delivery of the item by the seller's providing a download to the buyer) after having been paid for the item by buyer 102 using FSP 120 as intermediary at step 206.

Alternatively, for example, if buyer 102 has decided to send the item to a recipient (e.g., recipient 112 or the buyer 102 herself), the buyer 102 may be allowed, at step 212, to add the digital goods to a digital locker, such as one of the digital lockers 130, maintained by FSP 120. In one embodiment, the seller 108 may make a delivery for the item by providing a download of the item to the FSP for adding to a digital goods locker 130 (e.g., in this case a delivery for the item may include a delivery of the item by the seller 108 providing a download to the FSP for safekeeping—such as preserving copyright and other digital rights—in a digital goods locker 130 with later actual delivery, e.g., by FSP 120 from a digital goods locker, to a recipient). If, for example, the buyer (e.g., buyer 102) has elected to send the item to herself or to another person as recipient, the item may be placed in a digital goods locker 130 associated with the buyer's FSP account. Alternatively, if the buyer has elected to send the item to another person as recipient (e.g., recipient 112) and that person has an FSP account with FSP 102, the item may be placed in a digital goods locker 130 associated with the recipient's FSP account.

For some types of digital goods, e.g., games, it may be impractical or undesirable to provide a download other than directly to the end user of the digital goods. For example, buyer 102 may visit a game website of seller 108 and look at a game that the buyer wants to send to recipient 112. Buyer 102 may pay for the game using FSP 120 as an intermediary between buyer 102 and seller 108, as described at steps 202 and 206, but does not download the game either locally or to a digital goods locker. Instead, at step 214, the game may remain at the game website and a prepaid link to the game may be provided for the end user, recipient 112 (e.g., in this case a delivery for the item may include the seller's providing a prepaid link to the recipient end user for later actual delivery, e.g., download of the item directly to the end user using the prepaid link). In one embodiment, for example, the FSP 120 may enable the seller 108 to send a link to the end user, recipient 112, by providing network 106 address information to seller 108. The network address information may, for example, be known from the recipient's FSP account or may be provided by buyer 102 to FSP 120 during the payment process. With the use of the prepaid link at step 214, and not downloading the item locally or to a digital goods locker, the item may be paid for by the buyer 102, yet stays on the game website of seller 108, and recipient 112 may receive the prepaid link so that recipient 112 can download the item (e.g., a game in this example) directly from the seller 108. FSP 120 may thus avoid holding any digital goods rights to the item in so far as the item is transferred directly from the seller to the end user, and similarly, FSP 120 also may avoid copyright issues that arise only between the seller and the end user.

At step 216, FSP 120 may provide services to its users and account holders who have a digital goods locker associated with their account. For example, a user may be able to login to his or her FSP account and view a list of items that are held in his or her digital goods locker. In accord with, for example, digital goods rights and copyright requirements, a user (e.g., buyer 102 or recipient 112) may be permitted access to and disposal of items in the user's digital goods locker only if authorized.

So, for example, if a user, e.g., either a buyer or recipient, has one copy of a digital goods item in the user's digital goods locker 130, at step 218, the user may download the item locally to the user's device (e.g., device 104 for buyer 102, device 114 for recipient 112). The item is then removed from the user's digital goods locker 130, and the user has no further access to the item.

Similarly, for example, if a user (e.g., buyer 102) has one copy of a digital goods item in the user's digital goods locker 130, at step 220, the user may transfer the item to another user's (e.g., recipient 112) digital goods locker 130 for disposal by the recipient as the recipient sees fit, the item is then removed from the user's digital goods locker 130, and the user has no further access to the item. In this case, disposal by the recipient may include local download or transfer to another digital goods locker, but once the last copy in a digital goods locker 130 is disposed of, the recipient may have no further access to the item. If the desired recipient does not have an FSP account, an option may be provided to the user wishing to transfer the digital goods item to use email, for example, or an FSP account may be set up for the recipient, or a guest account and digital goods locker may be provided for the recipient.

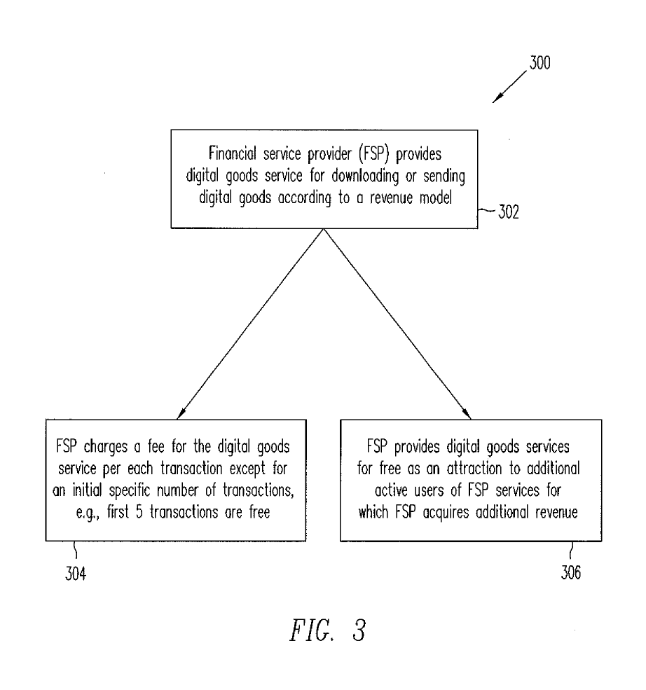

FIG. 3 illustrates, according to one or more embodiments, a method 300 for sending and receiving digital goods in a system for digital goods commerce such as system 100. At step 302 of method 300 a financial services provider, such as FSP 120, may operate a digital goods service for sending and receiving digital goods in a system for digital goods commerce, such as method 200 using system 100. The digital goods service may be operated in accordance with one or more revenue models so that the FSP may receive some benefit, for example, either pecuniary or an indirect benefit such as “good will” value, from operating the service.

At step 304, for example, FSP 120 may charge a nominal fee (e.g., a small fixed amount that is pre-specified) for each occurrence of buying and sending an item or multiple items in the same occurrence. As an enticement to use the service a pr-specified initial number, e.g., the first five, of occurrences may be offered free of charge. In a variant of the enticement, the service may be offered for an initial period of time, e.g., the first five months, free of charge. In this model, revenue may be generated by the nominal fee per transaction, and overall revenue may be increased by the enticement attracting more long term (e.g., a greater number of uses than the number of free initial uses) users than would otherwise occur. In an alternative embodiment, the fee per transaction, for example, may instead be charged as a percentage fee based on the amount of the transaction as opposed to a fixed, nominal fee. In another alternative embodiment, various structures may be applied to the transaction fee. For example, a user who is more active may receive a discount on the fee or, conversely, a lower fee may be offered as an enticement to more frequent use by less active users.

At step 306, for example, the digital goods sending and receiving service may be offered for free with an expectation of increasing the overall volume of business for the financial service provider, e.g., FSP 120. For example, if a recipient 112 receives an email notification from a buyer 102 that an item of digital goods has been purchased for the recipient and a link for picking up or receiving the digital goods is included in the email, the recipient 112 may click on or open the link. The link may take recipient 112 to a website of FSP 120 (e.g., using server 122) that may offer the recipient options including: 1) logging in to an existing FSP account if the recipient already has an FSP account; 2) a convenient, easy way to open a new account if the recipient does not already have an FSP account; or 3) logging in to a guest account for receiving the digital goods. It is expected that option (2), for example, may increase long term revenue by enlisting new subscribers or users of the services of FSP 120 so that, even if no immediate revenue is generated by the instant transaction, there is potential for the new user to more readily use the services of FSP 120 in the future now that the new user has an FSP account already opened up. Similarly, option (3) may attract new users of the services of FSP 120 by providing familiarity with the service and generating confidence in their use. Option (1) also may increase the goodwill business value of FSP 120 by providing an additional convenient service for an existing user. Thus, at step 306, each of options (1)-(3) may indirectly generate revenue through future use of services or increased use of services.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), a cursor control component (e.g., mouse or trackball) or any combination of the preceding. In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Logic may be encoded in a computer readable and executable medium, which may refer to any medium that participates in providing instructions to the processor for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the form of acoustic or light waves, such as those generated during radio wave and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, EPROM, FLASH-EPROM, any other memory chip or cartridge, carrier wave, or any other medium from which a computer is adapted.

In various embodiments, execution of instruction sequences for practicing the invention may be performed by a computer system. In various other embodiments, a plurality of computer systems coupled by communication links (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received or stored in a disk drive component (or some other non-volatile storage component) for execution or both.

Where applicable, various embodiments provided by the present disclosure may be implemented using hardware, software, or combinations of hardware and software. Also, where applicable, the various hardware or software components set forth herein may be combined into composite components comprising software, hardware, or both without departing from the spirit of the present disclosure. Where applicable, the various hardware components or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code or data, may be stored on one or more computer readable and executable media. It is also contemplated that software identified herein may be implemented using one or more general purpose or specific purpose computers or computer systems or both, networked or otherwise. Where applicable, the ordering of various steps described herein may be changed, combined into composite steps, or separated into sub-steps to provide features described herein.

The foregoing disclosure is not intended to limit the present invention to the precise forms or particular fields of use disclosed. It is contemplated that various alternate embodiments or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

1. A system comprising:
a processor for communication over a network with a buyer and a seller, the processor executing a process that provides an intermediary between the buyer and the seller wherein:
an interface is provided between the seller and the buyer for an item of digital goods via the intermediary; and
in response to a buyer decision expressed via the interface, a delivery that does not compromise digital rights protections of the item is made from the seller for the item of digital goods via the intermediary for disposal by the buyer.

2. The system of claim 1, wherein:
a payment is made via the intermediary for the item; and
the delivery via the intermediary for the item includes downloading the item to a digital goods locker.

3. The system of claim 1, wherein:
a payment is made via the intermediary for the item wherein a prepaid link to the item is provided; and
the delivery via the intermediary for the item includes providing the prepaid link to the item.

4. The system of claim 1, wherein:
a payment is made via the intermediary for the item wherein a prepaid link to the item is provided;
the deliver via the intermediary for the item includes providing the prepaid link to the item; and
the disposal includes sending a recipient the prepaid link which enables the recipient to download the item directly from the seller.

5. The system of claim 1, wherein:
the delivery via the intermediary for the item includes providing an information link for the item; and
the disposal includes sending a recipient the information link from the seller that provides information about the item to the recipient

6. The system of claim 1, wherein:
the delivery via the intermediary for the item includes downloading the item to a digital goods locker; and
the disposal includes providing the item from the locker to a recipient.

7. The system of claim 1, wherein:
the processor charges a nominal fee for the delivery to either the seller or the buyer, wherein the fee is not charged for an initial number of deliveries or the fee is not charged for an initial period of time.

8. A computer-implemented method comprising:
communicating via a computer network with a buyer and a seller so as to provide an intermediary between the buyer and the seller;
providing an interface, by a processor, via the intermediary from between the buyer and the seller for an item of digital goods; and
in response to a buyer decision expressed via the interface, making a delivery that does not compromise digital rights protections of the item from the seller for the item of digital goods via the intermediary for disposal by the buyer.

9. The method of claim 8, further comprising:
making a payment via the intermediary for the item; and wherein:
making the delivery via the intermediary for the item includes downloading the item to a digital goods locker.

10. The method of claim 8, further comprising:
making a payment via the intermediary for the item wherein a prepaid link to the item is provided; and wherein:
making the delivery via the intermediary for the item includes providing the prepaid link to the item.

11. The method of claim 8, further comprising:
making a payment via the intermediary for the item wherein a prepaid link to the item is provided; wherein:
making the delivery via the intermediary for the item includes providing the prepaid link to the item; and
the disposal includes sending a recipient the prepaid link which enables the recipient to download the item directly from the seller.

12. The method of claim 8, wherein:
making the delivery via the intermediary for the item includes providing an information link for the item; and
the disposal includes sending a recipient the information link from the seller that provides information about the item to the recipient

13. The method of claim 8, wherein:
making the delivery via the intermediary for the item includes downloading the item to a digital goods locker; and
the disposal includes providing the item from the locker to a recipient.

14. The method of claim 8, further comprising:
charging a nominal fee for the delivery to either the seller or the buyer, wherein the fee is not charged for some combination of an initial number of deliveries or an initial period of time.

15. A computer program product comprising a non-transitory computer readable medium having computer readable and executable code for instructing a processor to perform a method, the method comprising:
communicating via a computer network with a buyer and a seller so as to provide an intermediary between the buyer and the seller;
providing an interface via the intermediary between the buyer and the seller for an item of digital goods; and
in response to a buyer decision expressed via the interface, making a delivery that does not compromise digital rights protections of the item from the seller for the item of digital goods via the intermediary for disposal by the buyer.

16. The computer program product of claim 15 wherein the method further comprises:
making a payment via the intermediary for the item; and wherein:
making the delivery via the intermediary for the item includes downloading the item to a digital goods locker.

17. The computer program product of claim 15 wherein the method further comprises:
making a payment via the intermediary for the item wherein a prepaid link to the item is provided; and wherein:
making the delivery via the intermediary for the item includes providing the prepaid link to the item.

18. The computer program product of claim 15 wherein the method further comprises:
making a payment via the intermediary for the item wherein a prepaid link to the item is provided; wherein:
making the delivery via the intermediary for the item includes providing the prepaid link to the item; and
the disposal includes sending a recipient the prepaid link which enables the recipient to download the item directly from the seller.

19. The computer program product of claim 15 wherein
making the delivery via the intermediary for the item includes providing an information link for the item; and
the disposal includes sending a recipient the information link from the seller that provides information about the item to the recipient

20. The computer program product of claim 15 wherein:
making the delivery via the intermediary for the item includes downloading the item to a digital goods locker; and
the disposal includes providing the item from the locker to a recipient.
